(19) United States
(12) Patent Application Publication
(10) Pub. No.: US 2019/0254134 A1
(43) Pub. Date: Aug. 15, 2019

(54) METHOD FOR OPERATING A LIGHTING APPARATUS OF A MOTOR VEHICLE

(71) Applicant: Dr. Ing. h.c. F. Porsche Aktiengesellschaft, Stuttgart (DE)

(72) Inventors: Benjamin Hummel, Tamm (DE); Sascha Saralajew, Wiernsheim (DE)

(21) Appl. No.: 16/252,743

(22) Filed: Jan. 21, 2019

(30) Foreign Application Priority Data
Feb. 14, 2018 (DE) 10 2018 103 262.5

(51) Int. Cl. H05B 33/08; F21V 14/00; F21V 14/04

(52) U.S. Cl. CPC H05B 33/0845; F21Y 2105/16; F21V 14/04; F21V 14/003

(57) ABSTRACT

A method for operating a lighting apparatus for a motor vehicle includes producing an overall light distribution based on a desired light distribution and an aiming apparatus of a lamp using an algorithm. The lighting apparatus has at least one lamp configured to provide for illumination of surroundings of the motor vehicle, and the lamp has an overall light distribution that results from a multiplicity of light distributions from light sources of a light source module of the lamp in conjunction with a light shaping element.

### CROSS REFERENCE TO RELATED APPLICATIONS

This application claims benefit to German Patent Application No. DE 10 2018 103 262.5, filed Feb. 14, 2018, which is hereby incorporated by reference herein.

### FIELD

The invention relates to a method for operating a lighting apparatus of a motor vehicle.

### BACKGROUND

Today's lighting apparatuses for motor vehicles have a multiplicity of light sources, for example in the form of light-emitting diodes, what are known as LEDs, halogen lamps or xenon lamps. To produce a particular illumination that is supposed to be attained using the lighting apparatus, what are known as actuation values of the individual light sources need to be determined, with different constraints needing to be observed, such as, for example, laws, homogeneity and thermal constraints. Predominantly, these actuation values are ascertained manually.

Laid-open specification DE 10 2015 203 890 A1 reveals a method for operating a lighting apparatus, wherein the lighting apparatus has a plurality of illuminants as light sources that each produce an individual light distribution. The light sources are selected in order to produce a desired visual appearance.

Laid-open specification DE 10 2006 043 402 A1 discloses a lighting unit designed to have light sources in the form of LEDs arranged in accordance with a matrix. Positioned opposite the light sources is an optical element, the optical element having a switchable diffractive element that can be used to alter an amplitude of light emitted by means of the light sources that passes through this element. The adjustment of the diffractive element to bring about a desired pattern is effected by means of a calculation.

Similarly, besides the light sources in the form of LEDs, other light sources of the lamp can also influence and/or, depending on light conditions dependent on the driving situation, bring about the light distribution. This means that the lamp can have different forms of light sources, which are subsequently also referred to as contributors.

The individual light distributions of the light sources, regardless of whether they are in the form of an LED or in another form, for example of a standard bulb or in the form of halogen lamps, etc., overlap one another. This is required, since if the individual light distributions did not overlap then the overall light distribution would have gaps. On account of the overlap of the individual light distributions, an area of the overall light distribution is for the most part served by multiple light sources at the same time. This means that some areas of the overall light distribution are illuminated excessively strongly, and other areas are illuminated too little. This means that actuation values of the individual light sources, in other words the supply of power thereto and therefore the luminous intensity and/or luminous angle thereof, need to be ascertained as well in combination so that a mostly homogeneous light field and therefore a mostly homogeneous overall light distribution in the desired light field are realized.

High-resolution matrix lamp systems comprise a light-shaping element that can influence the overall light distribution, as can be gathered from laid-open specification DE 10 2006 043 402 A1. Therefore, determination of the individual actuation values, both of the light sources and of the light-shaping element, has a high level of, cost-intensive, manufacturing sophistication.

### SUMMARY

In an embodiment, the present invention provides a method for operating a lighting apparatus for a motor vehicle. The lighting apparatus has at least one lamp configured to provide for illumination of surroundings of the motor vehicle, and the lamp has an overall light distribution that results from a multiplicity of light distributions from light sources of a light source module of the lamp in conjunction with a light shaping element. The method includes producing the overall light distribution based on a desired light distribution and an aiming apparatus of the lamp using an algorithm.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 illustrates a basic design of a lamp;

FIG. 2 illustrates a desired light distribution; and

FIG. 3 illustrates an overall light distribution resulting from a method according to the invention based on the desired light distribution shown in FIG. 2.

### DETAILED DESCRIPTION

Embodiments of the present invention provide methods for a lighting apparatus that can be used to inexpensively bring about production of an overall light distribution.

A method according to the invention for operating a lighting apparatus for a motor vehicle, wherein the lighting apparatus has at least one lamp, by means of which there is provision for illumination of surroundings of the motor vehicle, has an overall light distribution of the lamp. The overall light distribution results from a multiplicity of light distributions from light sources of a light source module of the lamp in conjunction with a light-shaping element. According to the invention, the overall light distribution is produced on the basis of a desired light distribution and an aiming apparatus of the lamp using an algorithm. The substantial advantage of the method according to the invention is that, regardless of whether the overall light distribution is determined in an online mode of the motor vehicle or in an offline mode of the motor vehicle, substantially reduced sophistication is needed for providing the desired overall light distribution, as a result of which the lighting apparatus can be realized inexpensively.

A further advantage of the method according to the invention can be seen in that it is possible to change an already ascertained overall light distribution to a different aiming apparatus in a simple manner. That is to say, in other words, that the method according to the invention can be used to adapt already existing overall light distributions to other aiming apparatuses, i.e. other lamps, and it is similarly possible for particular overall light distributions to be ascertained for a particular aiming apparatus, that is to say for a particular lamp, on the basis of desired light distributions. These desired light distributions may likewise be already existing overall light distributions. A further advantage can be seen in that the lighting apparatus can be operated with minimal consumption in a fast and inexpensive manner.

Further advantages, features and details of the invention will emerge from the description of preferred exemplary embodiments that follows and on the basis of the drawing. The features and combinations of features cited in the description above and the features and combinations of features cited in the description of the figures below and/or shown in the figures alone can be used not only in the respectively indicated combination but also in other combinations or on their own without departing from the scope of the invention. Elements that are the same or have the same function have identical associated reference signs. In the drawings:

A motor vehicle not depicted in more detail has a lighting apparatus 1 comprising front and rear lamps. The lamps 2, in particular the front lamps, are in the form of what are known as high-resolution matrix lamps and each have a multiplicity of light sources 3, which are in the form of what are known as LEDs, and a lamp optical system 4, by means of which the light emitted by the light sources 3 specifically results in a particular overall light distribution 8, see FIG. 3, of the lamp 2 that is composed from the individual light distributions of the individual light sources 3, also referred to as contributors. The overall light distribution 8 can be matchable to the driving conditions of the motor vehicle.

The light sources 3 are in a matrix-like arrangement on a support 5, the support 5 with the light sources 3 also being able to be referred to as a light source module 5, which additionally comprises control elements for actuating the light sources 3. On the basis of the matrix-like arrangement of the individual light sources 3 in this exemplary embodiment, reciprocal influencing of the light sources 3 is obtained such that particular areas of a light distribution produced by means of the individual light source 3 are in stronger or weaker form, on the basis of an overlap between the light distributions of the individual light sources 3. That is to say, in other words, the reciprocal influencing of the light distributions of the individual light sources 3 requires a reduction and/or an increase in a luminous intensity of the individual light source 3 so that a light image, in other words the overall light distribution 8, can be realized, in accordance with a desired light image.

A control unit of the motor vehicle is coupled to the light source module 5 to adjust the overall light distribution 8 to be produced by means of the multiplicity of light sources 3. To this end, the individual light sources 3 are individually actuatable by means of the control unit, with operating parameters, in particular a brightness, of each light source 3 being variably adjustable.

As such, on the basis of a present driving situation of the motor vehicle, for example, the overall light distribution could be matched to this situation. That is to say, in other words, that in the event of a change in the direction of travel, for example in the event of cornering, and/or on the basis of a speed, for example, the overall light distribution 8 is matched to this situation. The present driving situation is denoted by means of different parameters, for example the speed of the motor vehicle, which are measured continuously, and these are processed in the control unit as appropriate.

Fundamentally, the overall light distribution 8 is based on the actuation of the light sources 3, a supply of current to the light sources 3 having an influence on a brightness of the light sources 3. That is to say, in other words, that the brightness of the light source 3 increases as current density rises. The supply of current, i.e. the current density supplied to the light source 3, is performed by means of the light source module 5. The supply of current to the respective light source 3 is based on what is known as an actuation value, which is ascertained by means of the method according to the invention and is forwarded to an element controlling the supply of current.

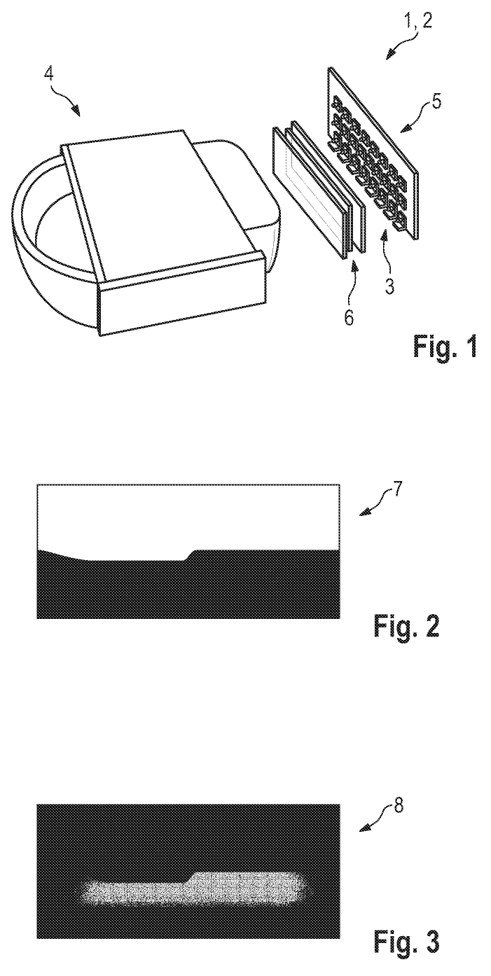

FIG. 1 depicts the lamp 2 in basic form. The lamp 2 has a plurality of light sources 3 in the form of LEDs. The light sources 3 are arranged in the form of a matrix. The number of light sources 3, and hence the number of pixels used in the light distribution, is individual to the manufacturer and individual to the motor vehicle, that is to say that there can be any number of them.

The actuation values ascertained by means of the method according to the invention are individual per light source 3. That is to say, in other words, that the light sources 3 do not imperatively have identical actuation values. Preferably, the actuation values are what are known as pulse-width modulation values.

The light source module 5 having the light sources 3 and the lamp optical system 4 have a further light-shaping element 6 arranged between them that influences the overall light distribution and that, by way of example, is embodied in the form of what is known as an LCD (liquid crystal display) element. However, it could also be another element influencing the overall light distribution 8 that can be regulated by means of further actuation values.

Therefore, a light image development apparatus is formed whose light source module 5 lights the light-shaping element 6 and prescribes basic properties of the overall light distribution 8. By means of the light-shaping element 6, the overall light distribution 8, in other words the light image projected by means of the lamp 2, is refined in comparison with a light image obtained simply from the light source module 5. This allows in particular a light/dark boundary to be formed in substantially more detailed fashion, in other words in more contrasted fashion.

Therefore, a two-stage light image development apparatus is formed, the actuation values of which are determined by means of the method according to the invention.

Determination of the actuation values is subject to constraints that are fundamentally known. These are in particular legal requirements, thermal limit values and homogeneity.

To ascertain a maximum possible heating that forms a thermal limit value, a characteristic value that is individual to the respective light source is used. If a prescribable limit of maximum heating is exceeded, then, according to the prior art, all of the actuation values would need to be predetermined again, and, as with the first calculation of the actuation values already, it goes without saying that particular attention needs to be paid to influencing of the light distribution of each individual light source 3 by in particular adjacent light sources 3.

The method according to the invention has an algorithm by means of which a desired light distribution 7, see FIG. 2, and an aiming apparatus that has the light sources 3 are taken as a basis for determining the actuation values critical for the aiming apparatus to bring about an overall light distribution 8 that is at least mostly consistent with the desired light distribution 7, see FIG. 3. This desired light distribution 7 is supposed to be realized at least approximately using the prescribed lamp 2, which comprises the light sources 3, the light-shaping element 6 and its lamp optical system 4.

The algorithm by means of which the actuation values necessary for bringing about the desired overall light distribution 8 are ascertained is based on a matrix and vector calculation, the least square error method and, as is necessary with overdetermined linear equation systems, a correction so that a specific selection is made given multiple solutions for an actuation value. This can involve simple elimination by means of retrieval of, by way of example, negative values. Similarly, the correction, or the specific selection of results, could exist by means of other mathematical functions.

In the present exemplary embodiment, the desired light distribution 7 and the aiming apparatus are converted into an electronically processable, in particular what is known as an illuminating engineering society (IES), format. Naturally, the apparatuses, such as the aiming apparatus 5 or the light-shaping element 6, for example, are not actually converted into a corresponding file format, but rather the properties consistent with and necessary for these apparatuses 5, 6 are stored in the applicable file format, preferably the IES format.

In this instance, each light source 3 or contributor is assigned what is known as an IES file. The aiming apparatus consistent with the actuatable elements light source module 5 is likewise in a format suitable for electronic processing, preferably likewise in the form of an IES file.

The so-called IES format is distinguished in that a light intensity is associated with the light source 3 at a location specified on the basis of two angles, the angles describing a measure of an in particular hemispherical emission of light from the light source 3. Therefore, a light source 3 can be assigned a matrix I_{L} that has the luminosity on the basis of the two angles. This matrix I_{L} is remolded to produce a row vector in order to determine the actuation values.

If a matrix I [symbol] for the desired light distribution 6 is involved, this matrix has a number of columns MWS and a number of rows MWZ. If the matrix I [symbol] of the aiming apparatus is involved, it has a number of columns MZS and a number of rows MZZ according to the number of light sources 3 of the light source module 5. The matrix I [symbol] of the aiming apparatus is furthermore remolded to produce a vector b. The matrix I [symbol] of the desired light distribution 6 is consistent with the matrix A cited below.

Finally, the actuation values of the aiming apparatus are determined by means of the least square error method according to the following equation x:

x=( [symbol] *b

If an overdetermined linear equation system is possibly involved, the ascertained actuation values gatherable from the vector x are selected. In this case, it would be possible, by way of example, to take the approach that all of the negative values are set to zero and all of the values greater than 1 are set to 1. Similarly, it would also be possible for a different selection to be made.

Therefore, the actuation values to be allotted to the light sources 3 of the aiming apparatus corresponding to the light source module 5 are now available for said aiming apparatus in a first step. These actuation values can finally be supplied to the light source module 5, which is used to operate the light sources 3 in a manner consistent with the actuation values. There is therefore now an intermediate image.

At this juncture, it can be stated for the method according to the invention in summary that, on the basis of the desired light distribution 7, actuation values for an intermediate image generable by means of the light source module 5 are determined in a first step and, in a second step, on the basis of a comparison of the desired light distribution 7 and the intermediate image, actuation values for the light-shaping element 6 are determined in order to attain an overall light distribution 8 that is consistent with the desired light distribution 7 as far as possible.

By way of example, it is also possible for already ascertained actuation values from overall light distributions 8 of other lamps to be used and to be processed further as desired light distribution 7. FIG. 2 illustrates, by way of example, a desired light distribution 7 that can be realized at least approximately. The area depicted in black corresponds to a pixel off, therefore an unlit area of the desired light distribution 7, and the white area corresponds to a pixel on, therefore a lit area of the desired light distribution 7.

Determination of the actuation values of the light source module 5 requires subjective properties of the high-resolution system, in other words the light-shaping element 6, to be taken into account and incorporated into the calculation as appropriate.

The method according to the invention is used to ascertain the individual actuation values, an approximation of the desired light distribution 7 being ascertained taking into account the overlap of the light distributions of the individual light sources 3 and the cross-influencing that occurs as a result of the overlaps.

The ascertained actuation values can be forwarded directly to the light source module 5 and the light-shaping element 6 and/or to other closed-loop and open-loop control systems of the motor vehicle, for example.

The number of light sources 3 and/or the number of pixels of the aiming apparatus and those of the desired light distribution 7 do not necessarily have to be the same and can then be matched to one another using a matching method.

The matching method involves the vector b being converted into a matrix B′. A sectional area, in other words an intersection, of the matrix A and the matrix B′ is ascertained and the remainder of the marginal areas, therefore the values dropping out of the intersection, are discarded. So that the matrix B resulting from the matrix B′ has the same dimension as the matrix A, the corresponding matrix positions are filled with a value of zero. Finally, the matrix B is converted into the vector b again so that it can be made available to the matrix equation cited above.

However, it should be borne in mind that the individual light distributions mean that a certain fuzziness of the ascertained overall light distribution 8 can fundamentally be expected and an overall light distribution 8 that corresponds or almost corresponds to the desired light distribution 7 is reliable only with a very large number of light sources 3, which are consistent with a reduction in a pixel size.

FIG. 3 illustrates the overall light distribution 8 based on the desired light distribution 7 shown in FIG. 2.

A further option is to take into consideration the homogeneity of the overall light distribution 8 mathematically, for example in the form of a vector. Similarly, there is the option of taking into consideration the thermal constraints mathematically in the algorithm and in this case of performing energy optimization, for example.

Fundamentally, the method according to the invention can be used for all multistage, high-resolution light modules, for example even with a light-shaping element 6 in the form of a digital micromirror device (DMD) module.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method for operating a lighting apparatus for a motor vehicle, wherein the lighting apparatus has at least one lamp configured to provide for illumination of surroundings of the motor vehicle, wherein the lamp has an overall light distribution that results from a multiplicity of light distributions from light sources of a light source module of the lamp in conjunction with a light-shaping element, the method comprising:
producing the overall light distribution based on a desired light distribution and an aiming apparatus of the lamp using an algorithm.

2. The method as claimed in claim 1, wherein actuation values of the light sources and/or actuation values of the light-shaping element to bring about the overall light distribution are ascertained.

3. The method as claimed in claim 1, wherein the light sources are of different types.

4. The method as claimed in claim 1, wherein the desired light distribution and/or the aiming apparatus and/or the light-shaping element are mapped in an IES format.

5. The method as claimed in claim 2, wherein the ascertained actuation values are available in an illuminating engineering society (IES) format.

6. The method as claimed in claim 2, wherein the ascertained actuation values are forwarded to further systems of the motor vehicle.

7. The method as claimed in claim 1, wherein the algorithm uses a matrix and/or vector calculation.

8. The method as claimed claim 1, wherein the algorithm uses a least square error method.

9. The method as claimed in claim 1, wherein the light-shaping element is a liquid crystal display (LCD) or a digital micromirror display (DMD) module.

10. The method as claimed in claim 1, wherein a matching method is used to determine the actuation values.
